(19) United States
(12) Patent Application Publication
(10) Pub. No.: US 2010/0131183 A1
(43) Pub. Date: May 27, 2010

(54) System for finding vehicles parked inside buildings and roofed surfaces

(76) Inventor: Carlos Antonio Gallo Garavano, Las Palmas (ES)

Correspondence Address: JACOBSON HOLMAN PLLC, 400 SEVENTH STREET N.W., SUITE 600, WASHINGTON, DC, 20004, US

(21) Appl. No.: 10/474,366

(22) PCT Filed: Apr. 8, 2002
(86) PCT No.: PCT/ES02/00171

§ 371 Date: Feb. 21, 2007

(30) Foreign Application Priority Data
Apr. 9, 2001 (ES) PO100838

(51) Int. Cl. G08G 1/127; G06F 17/00; G01C 21/00

(52) U.S. Cl. 701/200; 235/380

(57) ABSTRACT

To find an automobile or another vehicle that it was left parked, in spaces intended for such purpose, by means of widely used current technology, of simple use and without adding accessories to the vehicle.

Several devices, characterized by their modular design, the flat relative cartesian coordinates and computer programs, constitute the system jointly, that orienting and guiding the user to the parking space of his/her vehicle, who does not have to worry about its location.

This invention uses the following constituents: presentation box, programmed microcontroller, audiovisual electronic alerting unit (7), Smartcard connector (5), barcode laser scanner (8), LCD screen (6), power source, Smartcard (2.1), ticket-card with bar code (2.2), coordinates and computer programs.

The “Registering Post” (1.1) defines and registers the localization of the parked vehicle and the “Orienting Post” (1.2) visualizes the information in its LCD screen (6) to orient and guide the user, until finding his/her parked vehicle.

### OBJECT OF THE INVENTION

The present invention which is defended here, consists of a system conformed by several devices that allow to find an automobile or another vehicle parked in areas intended for said purpose, by means of widely used current technology, which are easy to use and do not require installing additional accessories in the vehicle.

For a better service to the user of the parking areas, it is convenient to have a device that orients and guides the user until the parking space of his/her vehicle, who does not have to worry about its location.

### BACKGROUND OF THE INVENTION

In the current parking, the only existing method to locate a parked vehicle later on, It is the identification of the parking space by means of the letters and digits combination, for example J320. It must be usually completed with the number of the floor or plant and the sector inside the floor or plant, being the localization as follows: floor 3, sector Cinema, street J, parking space 320. The range of colors, is used to delimit the different parking areas.

A form to palliate this problem, is that the user takes note of the code, either memorizing, recording or registering it electronically, or writing it in any element at his/her disposal, what means that he/she will have to transport some extra element in his/her pocket.

In these places any method that is based on the Global Position System (GPS), GLONASS or similar as the next Galilean lacks usefulness, because there are some obstacles (the own building) that interfere in the satellites signs which must be received by the navigator or receiving GPS installed in the vehicle, to define the exact position in coordinates, at the moment he/she leaves it parked.

When the user wants to find his/her parked vehicle, he/she has the same inconvenience with the receiving portable GPS, where previously it was also impossible to register the localization of the parking space in question. Also this coordinates used to have a short coming of at least 40 meters, unless it arrange differential phase or the DGPS corrections.

In the market there are different optic systems and/or mechanics and/or electronic and/or electromagnetic which solve the problem in question, but their biggest inconvenience reside in the high cost of installation and maintenance, due to its complexity, sophistication and the human personnel who must be devoted to be of that service. These systems can have interferences of different characteristics which diminish their effectiveness in the supposed solution, and which can transform them in unviable or little practical. It can consider that some of them attempt against the anonymity and people's intimacy, due to the type of data that they register.

Therefore it is continued depending on not making a mistake of building, of floor or plants, sector inside the floor or plant, sense of search at the moment to find the parked vehicle, lacking a device that orients and guides him/her to the search vehicle, without it means to add accessories to the vehicle or to have to carry some extra elements in his/her pocket.

The present invention allows to save the mentioned difficulties, using current technology, daily and simple use elements, which hierarchize the areas intended for parking vehicles, for its extra service that offers to the user.

The applicant in the search carried out in the databases linked to the O.E.P.M's web page, it didn't find another system to find parked vehicles, with the characteristics of the one is going to describe after, therefore it isn't known the existence of another similar device.

### EXPLANATION OF THE INVENTION

The main novelty of the invention, object of this presentation, it is based on the registration or storage of the localization of parked vehicle, in an appropriate support and its later process to be able to orient and guide the user until his/her vehicle, without getting wrong.

The cards with magnetic band or intelligent chip, it is the more spread support in this type of establishments, in order to getting paid for the time that the vehicle was parked, therefore it takes advantage of the mentioned support to store the localization, keeping up the same quantity of elements which are used at the moment and avoiding any type of added annoyance.

The system is characterized by its modular design which consists of the following components: a suitably programmed microcontroller, an audiovisual electronic alerting unit, a Smartcard connector, a bar code laser scanner, a LCD screen, a power source connected to the general net of electric fixtures, a presentation box, Smartcard, ticket-card with bar code, computer programs and flat relative cartesian coordinates, everything appropriately combine to get the objective.

The localization of the parked vehicle is defined by means of a system of flat relative cartesian coordinates, own and unique of the building or area intended for such purposed, that is materialized in the code to store. To this code is added the identification of the parking, to avoid the search in a mistaken building, also adding other data for an easy search.

A previous study of the parking, the later installation project of the invention now defended and the necessary investment, in such way that it were not a cost to the user, it will condition the quantity of each one of mentioned types posts which allow to define the localization code in relation to each parking space of itself, for its using after materializing the invention physically.

It is named “Registering Post”, to the place by means of a device registers or stores the localization code of the parked vehicle, being only used the nearest to the parking space in question, so that the later search were the correct one and “Orienting Post” to the place that by means of another device, partially different to the previous one, it gives the necessary orientation and guided to find the parked vehicle, being able to use whichever and every time that it were necessary until finding the searched place.

Once the vehicle is parked, the “Registering Post” registers or stores the localization code of the parking space, by means of the option that the parking has installed:
a) If it is bar code it is registered in the magnetic band card by means of a stamp of automatic ink (simile Trodat), pressing it by hand or also taking away the ticket-corresponding card, from the recipient intended for such purposed. b) If it is Smartcard, it is inserted in the corresponding connector, to record the data that have to store, taking away the card after finishing the recording, the one is indicated through an audiovisual sign.

The “Registering Post” of bar code, uses the stamp of automatic ink, where the usual support of rubber is stuck, this has recorded the localization code, needing a minimum cleaning maintenance and ink pad replacement with ink, as well as the verification of the quality impression. It also uses the ticket-card deposited in a recipient that needs the corresponding replacement, which are printed by means of a normal characteristics computer and the use of an appropriate shears, for its cut, generating a hand work. The printing program ticket-card, has stored the localization codes of each parking space. The “Registering Post” of Smartcard is electronic and automatic and when detecting the insertion of the card in the Smartcard connector, it carries out the recording of the data belonging to the localization code.

The “Orienting Post” has among its devices, the suitable lector of the support used to register or store the localization code of the parked vehicle, being a completely electronic and automatic process. If the support is of bar code, it has a laser scanner with a good configurations, for the used format among its constituents, so that it is activated and read automatically before the presence inside its influence area, of the magnetic band card or the ticket-card which have registered the corresponding localization code. The “Orienting Post” for Smartcard support, has a Smartcard connector among its constituents, turning on mechanics-electronically to the microcontroller when the card is inserted in its interior and being carried out the lecturing in automatic way.

The microcontroller processes the localization code, in order to visualize in the retro-illuminated LCD screen, by means of an alphanumeric text, the information that will allow to orient and guide the user which requests it, until the searching parking space. The different informations which can be visualized, they allow us to know if the building, floor or plants and sector inside the floor or plant are the correct ones, to be able to begin the properly search, when we are in the nearest area to the searched vehicle.

In the system of flat relative cartesian coordinates, the difference in the axis “z” (vertical), will indicate the quantity of floors or plants, expressed in units which it must be up or down, to arrive at the right place. In most of the establishments intended for parking, the circulation streets inside the same have a distribution of rectangular form, having as norm the axis “x” parallel to the biggest length streets and the axis “y” parallel to the smallest length streets. When we are in the nearest area to the searched vehicle, the information that is visualized it is the following one: a) steps to walk along the street of the “Orienting Post” (axis “x”), in the indicated direction in the LCD screen and that it coincides with the distance expressed in meters (difference of coordinates axis “x”) existing between the “Orienting Post” and the normal point to the parking space in question, on the street that we are going through. b) to get to the normal point we must turn to the left or to the right, according to the result of the difference of the coordinates in the axis “y” between the mentioned normal point and the parking space in question c) steps to walk along the normal to the street of the “Orienting Post” (axis “y”), until get to the parked vehicle which was looked for, and that it coincides with the distance expressed in meters (difference of coordinates axis “y”) existing between the mentioned normal point and the parked vehicle.

The invention which is defended here, it checks the different processes, through different computer programs designed especially to such effect and which are registered in the microcontroller memory, during the installation of the system.

The computer program installed in the microcontroller, it is mainly designed to control the following processes: a) the manage of the system of flat relative Cartesian coordinate, in all the calculations that the invention carries out b) the recording and lecturing of the localization code of the parked vehicle in the Smartcard c) the data admission sent by the laser scanner, corresponding to the lecturing of the cards which register the localization code, by means of the corresponding bar code d) the visualization of the different informations in the LCD screen that they orient and guide to the user who requests it, to find his/her vehicle e) the control of audiovisual electronic alerting unit f) reset the system g) the lecturing and memorization of the “Post” coordinates h) the auto-checking of the “Post” correct initiation i) the control of the correct operation of the different devices of the system j) the control of the language change that will be used in the visualization of the informations.

In the “Orienting Post” in order to achieve a biggest universality, it is able to choose the language in which we want to visualized the informations in the LCD screen, being able to achieve this selection, pressing once the idiom button corresponding to the wanted language. For not increasing the installation costs, a space problem for the buttons and memory to have kept the text to visualize, it limits that selection to less than ten options that will allow to select the more used languages in the area where the system is installed.

The audiovisual electronic alerting unit has the function of indicating in which situation it is, the recording or the lecturing of the localization code of the parked vehicle. There is a colour visual sign and quantity of Led and an acoustic sign taken place by the loudspeaker that identifies the moment in which the microcontroller is carrying out the lecturing or recording of the mentioned data, also allowing to know easily when these processes finish by means of the different characteristics of the audiovisual sign.

The power sources that the computers use, they improve the modular design and mainly satisfy the necessities of electric power supply to the tension and strength necessary, of the different electronic constituents of the system and being connected to the domiciliary general net of electric fixtures, through their transformers.

The box or wrapping has as main function, the protection of the devices that contains inside, the execution of the electric security norms and the perfect visualization of the “Posts”, for their identification, also taking advantage of its construction in order to facilitate the system assembly, to show the logo of the product, the use guide itself, a commercial presentation of the product and others.

### DESCRIPTION OF THE DRAWINGS

To facilitate the understanding of the present invention characteristics, it is added below a descriptive memory of several figures, in those that with illustrative and never limitative character, the following thing has been represented:

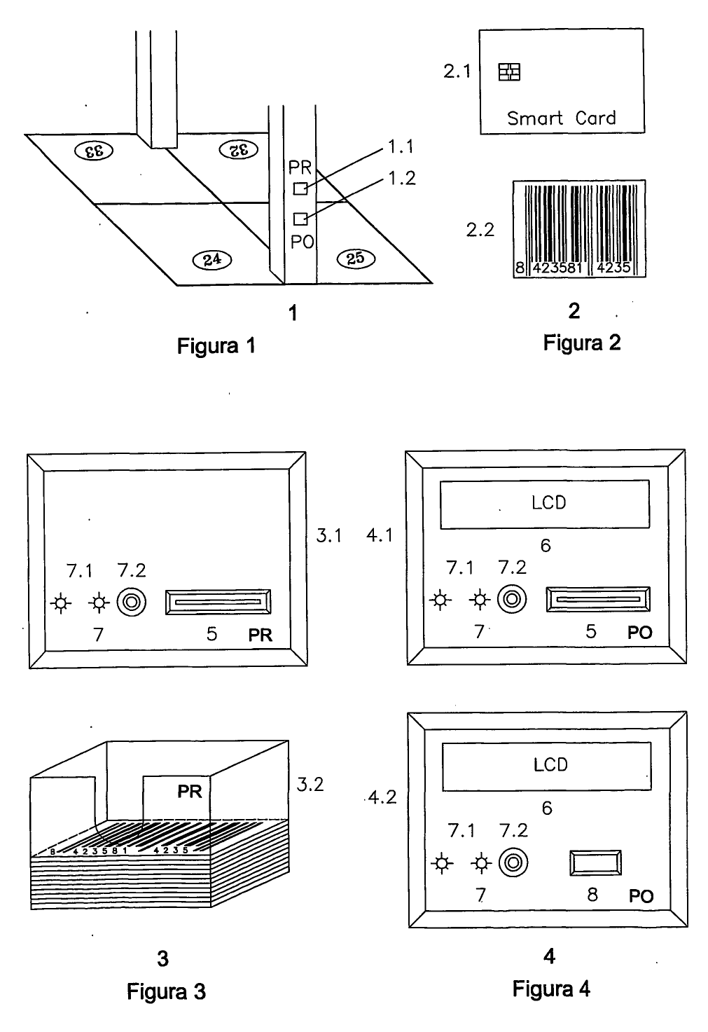

The FIG. 1 shows a perspective view of a small parking area, where we distinguish four parking space and two columns belonging to the building that have anchored the “Registering Post” (1.1) and the “Orienting Post” (1.2).

The FIG. 2 shows a perspective view of the two types of available data support, the Smartcard (2.1) and the magnetic band card or the ticket-card, with its bar code (2.2) in the appropriate format.

The FIG. 3 shows a perspective view, of a part of the two types of available “Registering Post, the Smartcard (3.1) and the bar code (3.2), with its stamp of automatic ink and recipient.

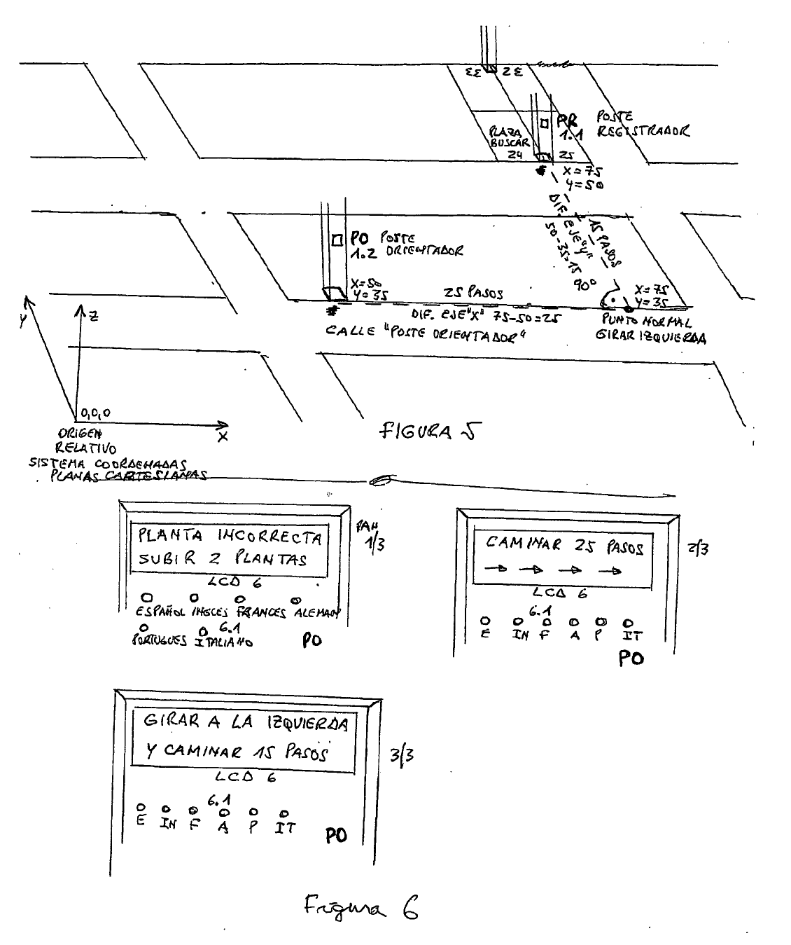

The FIG. 4 shows a perspective view of the two types of available “Orienting Post”, the Smartcard (4.1) and the bar code (4.2)

The FIG. 5 shows a perspective view of a small parking area, where we distinguish the way for finding the vehicle parked starting from the information facilitated by the “Orienting Post” (1.2) and according to the system of flat relative cartesian coordinates.

The FIG. 6 shows a perspective view of the LCD screen (6) visualizing some of the informations to orient and guide the user that requests it and the buttons (6.1) that allow to change the language of the text to read.

### EXPOSITION OF THE WAY TO CARRYOUT THE INVENTION

According to the previously enunciated, the present invention refers to the Systems for Finding Vehicles Parked Inside Buildings and Roofed Surfaces, characterized by a modular design which consists of the following modules: a suitably programmed microcontroller, an audiovisual electronic alerting unit (7), a Smartcard connector (5), a barcode laser scanner (8), a retro-illuminated LCD screen (6), a power source connected to the general net of electric fixtures, a presentation box, the Smartcard (2.1) and the magnetic band card or the ticket-card with bar code (2.2).

The Smartcard (2.1) has normal characteristics, not needing protection neither special security, should allow the use of the protocol I2C during the lecturing and recording what places, it in the range of daily use.

The Smartcard connector (5) for intelligent card (2.1) has normal characteristics, doing the contact by touching down with the objective of not damage the card contact existing a detector contact which indicates the insertion itself. When the lecturing or recording of the card finishes, the system is prepared for the different expulsion types of itself that are automatic or manual, being able to use in the realization of this invention, the simple method of pushing and dropping.

The audiovisual electronic alerting unit (7) is compound of a led group (7.1) and a buzzer (7.2), generating a visual sign (quantity and colour) and another acoustic, by means of which it is identified the processes that the microcontroller is carrying out.

The laser scanner (8) for the lecturing of the barcode ticket (2.2), has normal characteristics, configured for the automatic lecturing when the ticket is in the influence scanner area. The system is prepared for different types of format codes and inter phase of communications, being able to use the RS-232 in the data transmission with the microcontroller.

The retro-illuminated LCD screen (6), alphanumeric has normal characteristics, it optimizes the visualization of the informations that are shown to the user that requests it. Among them there is screens of 80 characters (20×4) distributed in 4 lines, with big characters that collaborate with the clarity of what is written. The communication with the microcontroller is carried out through a bus of data and another of commands, being allowed its control in that way.

The buttons (6.1) that allow to carry out the language selection in which the informations will be visualized in the LCD screen, they are completely normal and they don't have any special characteristics to keep in mind.

The power source is the necessary to be able to give the tension of 5 volt to the electronic constituents of the system, being linked to the domiciliary general net of electric fixtures. The biggest consumption is due to the retro illumination of the LCD screen that is about 1000 mA that must be added to the 300 mA that the rest of the electronic circuit can consume.

The microcontroller has normal characteristics, being without inconveniences in the market, being of 18, 28 or 40 the quantity paws which are used for its communication with the electronic circuit that surrounds it. The speed is not of importance, due to the processes are not complex neither long, therefore there are not delays in the times of execution. The quantity of necessary memory intended for programs and data, it is satisfied using microcontroller families of more than 1 Kbytes for the first one and of 256 bytes for the second one.

The box or wrapping allows to set up, to hold and to protect the different constituents, being its perfect visualization the one makes easy the identification of the “Posts.” They take the manual use of the system and they are anchored by means of screws to the walls or columns, where they are installed according to the optimum of the system.

In the reproduction of this invention for an expert, the existence of variations in materials, forms, size and constituents disposition, these don't affect to the essential of itself, which were described in a no limitative way.

What is claimed is:

1. Systems for Finding Vehicles Parked Inside Buildings and Roofed Surfaces, characterized by having got two types of modules (1), that can contain a Smartcard connector, a bar code laser scanner, a retro-illuminated LCD screen, a languages selector, an audiovisual electronic alerting unit, a power source connected to the general net of electric fixtures, a microcontroller integrated in the electronic circuit and a presentation box.

2. The system according to the preceding claim, characterized by having got two types of modules (1): a) the “Registering Post” (1.1) allows to register or store in the data support (2) used by the parking, the localization code of the parked vehicle, being necessary its installation only in parking areas. b) the “Orienting Post” (1.2) allows to orient and guide the user until finding his/her parked vehicle, based on the lecturing registration of the data support (2), being able to install in accesses, entries, corridors, stairways, parking areas, and so on, where the quantity of these modules will be condicionated by the optimum service.

3. The system according to the preceding claims, characterized because the “Registering Post” (3) has got to use two types of data support (2) in the localization register of the parked vehicle: a) the Smartcard (2.1), that is electronically recording, when it is inserted in the connector (5). b) ticket-card of bar code (2.2), that must be remove from recipient (3.2) puts for such effect. c) magnetic band card where the bar code (2.2) is registered, by means of the stamp of automatic ink (simile Trodat), pressing it by hand. (3.2).

4. The system according to the preceding claims, characterized because the “Orienting Post” (4) has got to recover the localization of the parked vehicle, registered from the data support (2), of two types of lectors: a) Smartcard connector (5) being activated the reading, when the Smartcard (2.1) is inserted. b) laser scanner (8) being activated the lecturing, when the magnetic band card (2.2) passes by its influence area, or the ticket-card (2.2) where the bar code was registered, according to the used format.

5. The system according to the preceding claims, characterized because the “Post Orienting” (4) has got a retro-illuminated LCD screen (6), with an alphanumeric text to visualize the information that allows to orient and guide the user that requests it, until finding his/her parked vehicle.

6. The system according to the preceding claims, characterized because the two types of modules (1), to identify what type of process is executing by the microcontroller, they have got the audiovisual electronic alerting unit (7), which is compounded by a visual colour sign and quantity of Led (7.1) and an acoustic sign taken place by the loudspeaker (7.2).

7. The system according to the preceding claims, characterized because the two types of modules (1), have got a microcontroller integrated in an electronic circuit, which controls all the processes that are executed in the system, by means of a structured computer program and designed especially to develop the necessary functions and that it is registered in the microcontroller memory, when the system is installed.

8. The system according to the preceding claims, characterized because the computer program that is installed in the microcontroller, it mainly controls the following processes: a) the manage system of flat relative cartesian coordinates. b) the recording and lecturing in the Smartcard of the localization code of the parked vehicle. c) the data admission sent by the laser scanner, corresponding to the lecturing of cards with bar code d) the visualization in the LCD screen of the different informations. e) the control of the audiovisual electronic alerting unit f) reset the system g) the lecturing and memorization of the “Post” coordinates h) the auto-checking of the “Post” correct initiation i) the control of the different devices correct operations of the system j) the control of the language change in which the informations are visualized.

9. The system according to the preceding claims, characterized by using a system of flat relative cartesian coordinates, to define the localization of each parked vehicle, which they are own and unique of each parking space intended for parking inside the same building or space used for parking.

10. The system according to the preceding claims, characterized because in the system of flat relative cartesian coordinates, the difference in the axis “z” indicates the quantity of floors or plants expressed in unities which it must be up or down, to get to the right place, the difference in the axis “x” and in the sense that the LCD screen indicates, it expresses the quantity of meters the parked vehicle is, according to the walking by the street of the “Orienting Post” and the difference in the axis “y” expresses the quantity of meters the parked vehicle is far from the previous street to the right or to the left, as it is the difference in the axis “y” positive or negative.

11. The system according to the preceding claims, characterized because the Smartcard (2.1), used as data support (2), it isn't personalized to a parking in exclusiveness, being able to use the same card, in all the parkings or parking that have installed the system of this invention.

12. The system according to the preceding claims, characterized because the “Orienting Post” possesses a series of buttons that allow to choose the language in which we want to visualize the informations in the LCD screen, pressing once the corresponding to the selected language.
